(19) United States
(12) Patent Application Publication
(10) Pub. No.: US 2005/0110260 A1
(43) Pub. Date: May 26, 2005

(54) Telescopic stabilizer

(76) Inventor: Rene Jacques, Roxton Pond (CA)

Correspondence Address: INVENTARIUM, Suite 1607, 4050 Rosemont blvd, Montreal, QC, H1X 1M4, CA

(21) Appl. No.: 10/991,646

(22) Filed: Nov. 18, 2004

Related U.S. Application Data
(60) Provisional application No. 60/523,292, filed on Nov. 20, 2003.

(51) Int. Cl. B60S 9/02

(52) U.S. Cl. 280/763.1; 280/475

(57) ABSTRACT

A telescopic stabilizer for travel trailer, fifth wheel, or motorhome which can extend to the required length no matter the distance between each jacks and is set up diagonally so that it creates a cross beam of sort which reinforces and stabilizes two otherwise separate jacks. Moreover, when a second telescopic stabilizer is added to a third jack or riser and set perpendicular to the first two, this creates a second axis to provide ultimate stability across the width and the length of the travel trailer, fifth wheel, or motorhome. More stabilizers can be added to cover all corners of the travel trailer, fifth wheel, or motorhome if required.

This application claims priority based on provisional application 60/523,292 filed Nov. 20, 2003.

### BACKGROUND OF THE INVENTION

1. Field of the Invention

The invention relates generally to leveling and stabilizing equipment but more particularly to a telescopic stabilizer designed for fifth wheels, travel trailers, or motorhomes.

2. Background of the Invention

Camping is a very popular activity and some people like to camp out at one location for an extended period of time, moreover, they want all the comforts of home and that includes a stable and level place, whether a fifth wheel, travel trailer, or motorhome.

There are several means for leveling and stabilizing a travel trailer, fifth wheel, or motorhome, some are home made using jacks and wooden blocks while others come with the travel trailer, fifth wheel, or motorhome or are bought as kits.

Some of those invented products are for holding and stabilizing a vehicle mounted travel trailer such as those on pickup trucks and, as described in U.S. Pat. No. 6,168,227 which consists in a pair of elongated frame members mounted in parallel to the bottom of a camper. A pair of leg assemblies are pivotally supported intermediate the elongated frame members. Each leg assembly includes a crossbar, a pair of outer sleeves attached to the crossbar, and a pair of telescoping members with each telescoping member being positioned at least in part within a respective one of the outer sleeves. Each telescoping member has a plurality of holes, a selected one of which is engaged by a pin passing through the respective outer sleeve to fix the length of each leg. Each leg assembly is fixed in the extended position by a pair of detachable braces. The leg assemblies are folded to lie flat against the bottom of the camper to permit the camper to be mounted on the bed of a truck.

Others provide folding legs held onto a subframe structure, such as in U.S. Pat. No. 3,933,372 and which consists in a pair of extensible leveling and stabilizing legs connected pivotally to the underside of a trailer, the legs can be raised from their ground engaging position extending downward to the ground in an outward direction transverse to the longitudinal axis of the trailer, to a retracted position extending parallel to the underside of the trailer. Force means are provided which tend to move the legs toward each other and thus continuously maintain stabilizing and leveling contact of the ground engaging portion of the legs with the ground. The force means can also be used to maintain the legs in a raised and retracted position.

Others are more concerned with lateral motion stabilization such as against strong winds such as U.S. Pat. No. 4,268,066 and which consists in an elongated strut having first and second large and small diameter relatively telescoped opposite end portions. The free end of the large diameter end portion includes a mount for mounting a corresponding vehicle side with the strut downwardly and outwardly inclined from the vehicle side. The free end of the small diameter end portion includes a relatively extendable spring biased foot portion for engagement with the ground and a generally horizontal brace is provided including a first end for anchoring relative to the corresponding vehicle side and a second end including clamp structure removably clampingly engaged with the strut small diameter end portion immediately adjacent and abutting the corresponding strut large diameter end portion to limit telescoping of the small diameter strut end portion into the strut large diameter end portion.

Still others offer a stand for the part normally held on a hitch as for fifth wheel trailers such as U.S. Pat. No. 5,141,197 which consists in a mountable support for a modular unit, such as a camper body, including telescoping support pillars with pivotal pads as well as telescoping arms for longitudinal support against inadvertent forward or rear section rotation from the support position, which is affixed to the body for storage at a reference position and having pivotal forward and rear sections for rotation to a support position for storage of the body after its removal from a transport vehicle bed.

Lifting a trailer and leveling it is simple enough but once lifted, are the jacks stable enough to carry the weight and the weight shifts caused by wind; or people moving inside the travel trailer, fifth wheel, or motorhome; or shifting tires and suspension; or the vibrations surrounding a trailer coming from traffic and other such sources of vibrations? There is therefore a need for an efficient and practical stabilizer.

### SUMMARY OF THE INVENTION

In view of the foregoing disadvantages inherent in the known devices now present in the prior art, the present invention, which will be described subsequently in greater detail, is to provide objects and advantages which are:

A first object of this invention to provide for a telescopic stabilizer that is safe and secure.

It is a second object of this invention to provide for a telescopic stabilizer that is easy to mount and dismount. Since it is permanently fixed underneath the travel trailer, fifth wheel, or motorhome itself.

It is a third object of this invention to provide for a telescopic stabilizer that takes very little space when not in use.

It is a fourth object of this invention to provide for a telescopic stabilizer that does not use storage space usually needed for blocks, jacks and related paraphernalia as is often the case when using traditional stabilizing methods.

It is therefore an advantage of the present invention to provide a telescopic stabilizer which can extend to the required length no matter the distance between each jacks and is set up diagonally so that it creates a cross beam of sort which reinforces and stabilizes two otherwise separate jacks. Moreover, when a second telescopic stabilizer is added to a third jack or riser and set perpendicular to the first two, this creates a second axis to provide ultimate stability across the width and the length of the travel trailer, fifth wheel, or motorhome. More stabilizers can be added to cover all corners of the travel trailer, fifth wheel, or motorhome if required.

Once the components are installed underneath a travel trailer, fifth wheel, or motorhome, they remain there and need be deployed only when needed, and retracted when no longer needed.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

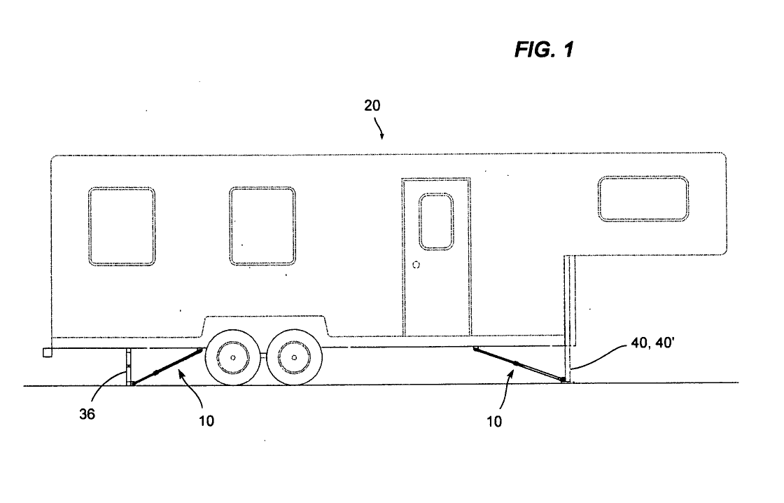

FIG. 1 Side elevation of a fifth wheel, in ghost lines, showing two telescopic stabilizers and two jacks.

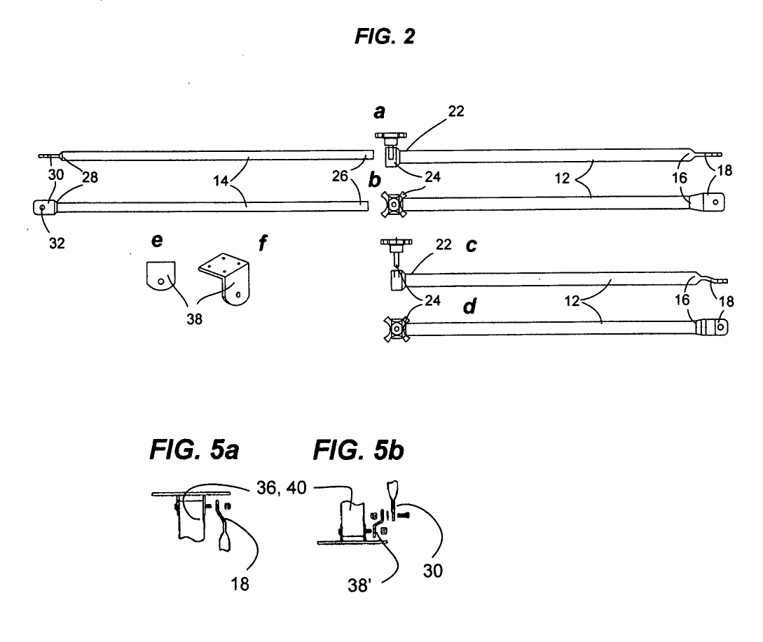

FIG. 2ab Side and top elevation of a complete telescopic stabilizer, respectively.

FIG. 2cd Side and top elevation of the first part of a variation of a telescopic stabilizer, respectively.

FIG. 2ef Side and isometric view of an attachment bracket, respectively.

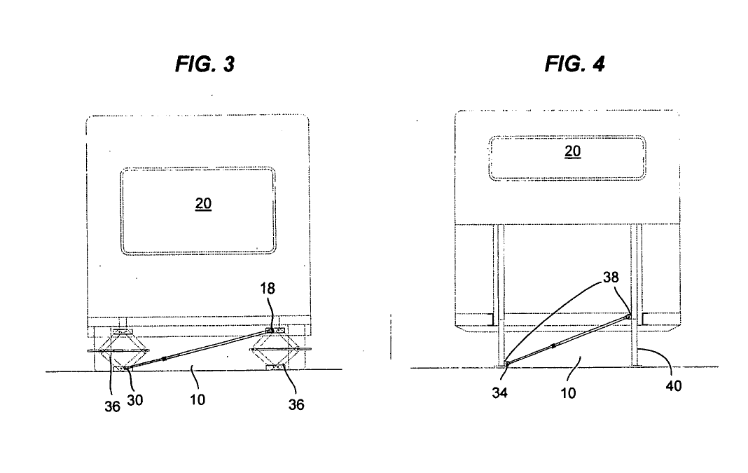

FIG. 3 Rear elevation of a fifth wheel, in ghost lines, showing one telescopic stabilizer set at a right angle from the one seen in FIG. 1.

FIG. 4 Font elevation of a fifth wheel, in ghost lines, showing one telescopic stabilizer.

This figure, along with FIGS. 1 and 3 show that a total of 4 telescopic stabilizers set along two perpendicular axes can be used to provide adequate stability. More telescopic stabilizers can be used in intermediate locations.

FIGS. 5ab Side elevation details of mechanical connections to top (a) and bottom (b) of jacks or risers.

### DETAILED DESCRIPTION OF THE PREFERRED EMBODIMENT

FIGS. 1 and 2 A telescopic stabilizer (10) for use on travel trailer, fifth wheel, or motorhome (20) has two sections: a hollow section (12) which receives a telescoping section (14). A hollow section first end (16) has a connector (18) extending therefrom and from which is connected a structural bracket (38). This structural bracket (38) is so named because it is mechanically connected to the structure of the travel trailer, fifth wheel, or motorhome (20) itself but is not limited to just that, it can also be connected to a jack (36) or a riser (40) for connecting with another telescopic stabilizer (10) which is set perpendicularly to form a second axis. An alternate structural bracket (38′) can be seen in FIG. 5b so as to provide as much versatilty and adaptability to risers (40) which are normally part of a travel trailer, or fifth wheel and jacks (36) which are bought separately. A hollow section second end (22) has an adjustment means (24) to selectively release or block the telescoping section (14) so that the overall length of the telescopic stabilizer (10) can be adjusted. As an example, a threaded knob is shown here as the adjustment means (24). The telescoping section (14) has a telescoping section first end (26) which is always encased within the hollow section (12) and a telescoping section second end (28) having a tabbed connector (30) extending therefrom. This tabbed connector (30) has a hole (32) so that a bolt (34) can pass through it, a nut can even be screwed to further secure the telescopic stabilizer (10) to the base of the jack (36) at one end of the telescopic stabilizer (10) and the top of the jack (36) at the other end of the telescopic stabilizer (10) as shown in FIG. 3, or in greater detail in FIGS. 5ab. Risers (40) can also be substituted to jacks (36).

FIGS. 2cd show a variation of the hollow section (12) wherein the connector (18) is bent so as to more readily adapt to the type of connection required whether on the jack (36), riser (40) or structural bracket (38).

As FIG. 4 shows, there are different kinds of jacks (36) or risers (40) and using the <<L>> shaped structural bracket (38) allows it to be installed easily on one riser (40) from which the hollow section first end (16) is connected as well as the other riser (40′) along with a bolt (34) so that the tabbed connector (30) can be inserted into.

Besides the lateral connections of the telescopic stabilizer (10) as per FIGS. 3-4, a longitudinal connection as per FIG. 1 is also possible in which case one structural bracket (38) is connected to the travel trailer, fifth wheel, or motorhome (20) and the other structural bracket (38) at the base of a jack (36) or riser (40, 40′). These connections along two axes act as cross beams which provide for an excellent stabilization of the jacks (36), risers (40, 40′) and ultimately, the travel trailer, fifth wheel, or motorhome (20) itself.

Once a camping location has been selected, the jacks (36) or risers (40, 40′) are deployed until a satisfactory degree of leveling has been achieved. By being secured along the length axis, even if the wheels are not properly blocked there is no possible shifting because of the crossbeam.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A telescopic stabilizer for use on travel trailer, fifth wheel, or motorhomes comprising:
a hollow section to receive a telescoping section;
said hollow section further comprised of a hollow section first end and a hollow section second end;
said hollow section first end having a connector extending therefrom and connecting to a structural bracket and said hollow section second end having an adjustment means to selectively release or block said telescoping section;
said telescoping section having a telescoping section first end and a telescoping section second end;
said telescoping section first end being encased within said hollow section and said telescoping section second end having a tabbed connector extending therefrom;
said structural bracket being connected to any of three possible locations, namely the structure part of the travel trailer, fifth wheel, or motorhome; a jack; or a riser as the case may be so as to provide said telescopic stabilizer with a cross beam configuration between any combination of structure part of a travel trailer, fifth wheel, or motorhome, jack, or riser;
said cross beam configuration being along at least one axis.

2. A telescopic stabilizer for use on travel trailer, fifth wheel, or motorhomes as in claim 1 wherein:
said hollow section second end's adjustment means to selectively release or block said telescoping section being a threaded knob.

3. A telescopic stabilizer for use on travel trailer, fifth wheel, or motorhomes as in claim 1 wherein:
said tabbed connector having a hole so that a bolt can pass through it.
